(19) United States
(12) Patent Application Publication
(10) Pub. No.: US 2003/0016745 A1
(43) Pub. Date: Jan. 23, 2003

(54) Multi-channel image encoding apparatus and encoding method thereof

(76) Inventors: Goo-Man Park, Seoul (KR); Jung-Whan Jang, Seoul (KR); Goo-Ho Kang, Suwon-city (KR)

Correspondence Address: Robert E. Bushnell, Suite 300, 1522 K Street, N.W., Washington, DC, 20005, US

(21) Appl. No.: 10/052,552

(22) Filed: Jan. 23, 2002

(30) Foreign Application Priority Data
Jul. 23, 2001 (KR) 2001-44225

(51) Int. Cl. H04N 7/12

(52) U.S. Cl. 375/240.03; 375/240.12; 375/240.2; 375/240.23

(57) ABSTRACT

A multi-channel image encoding apparatus for selectively receiving image signals transmitted through a plurality of input channels and encoding the image signals. The multi-channel image encoding apparatus includes a channel data processor that has a frame buffer group having a plurality of frame buffers for each input channel in order to receive a plurality of frame data through the plurality of input channels and to store the plurality of frame data, the channel data processor for selecting the data transmitted to the frame buffer group to output the selected data, and an encoder for encoding image signals output from the channel data processor with an MPEG method. According to the multi-channel image encoding apparatus and the encoding method thereof, signals for each channel input through a plurality of input channels can be transmitted in turn regardless of a similarity between the channels and a compression rate is increased, since data of the same channels having a high similarity is compared and encoded.

### CLAIM OF PRIORITY

This application makes reference to, incorporates the same herein, and claims all benefits accruing under 35 U.S.C. §119 from an application for MULTI CHANNEL IMAGE ENCODING APPARATUS AND ENCODING METHOD THEREOF earlier filed in the Korean Industrial Property Office on Jul. 23, 2001, and there duly assigned Serial No. 44225/2001 by that Office.

### BACKGROUND OF THE INVENTION

1. Field of the Invention

The present invention relates to a multi-channel image encoding apparatus and an encoding method thereof, and more particularly to a multi-channel image encoding apparatus and an encoding method capable of selectively encoding image signals input through a plurality of input channels.

2. Description of the Related Art

An image encoding system based on the MPEG (Moving Picture Experts Group) standard is a representative encoding method for motion pictures. The MPEG standard was introduced as a standard by ISO (International Organization for Standardization)-IE/JTC1/SC2/WG11. The MPEG standard applies a hybrid system, which uses a combination of discrete cosine transform encoding and movement compensation prediction encoding.

The above compressing method can obtain a high-rate of compression, when the similarity of consecutively displayed images is high. For example, when encoding the image consecutively input from one camera by using the MPEG method, the high compression rate can be obtained, since the similarity of adjacent frames is high.

However, when the image signals are input in turn from a plurality of input channels, the similarity of adjacent image information is low, thus the MPEG encoding method cannot be applied. There is a security system that supports multi-channel watching that is used when receiving the image signals in turn from the plurality of input signals.

The multi-channel security system consecutively selects the images input from cameras through a plurality of channels, records and displays the images. For example, when establishing a system capable of displaying the image signals input from four cameras by dividing into four on a display device and recording the image information for each channel, the multi-channel security system consecutively selects the four channels, displays the image signals input in turn for each channel on a display device and records the image signals.

However, the system mostly applies a WAVELET or a JPEG (Joint Photographic Experts Group) method that independently encodes for each image information, since the system consecutively selects the channels and the relativity of the input image signals is low. In the above-mentioned conventional multi-channel encoding system, if a compression art of MPEG is applied, when the image signals are transmitted in turn from the plurality of input channels, the complexity will be increased and it will be hard to obtain a desired compression rate.

### SUMMARY OF THE INVENTION

It is therefore an object of the present invention to provide a multi-channel image encoding apparatus and an encoding method thereof capable of increasing a compression rate in regard to images input in turn from a plurality of input channels.

It is another object of the present invention to provide a multi-channel image encoding apparatus and an encoding method thereof capable of increasing the compression rate even when employing the existing MPEG encoding method.

The multi-channel image encoding apparatus according to the present invention selectively receives image signals transmitted through a plurality of input channels and encoding the image signals. The multi-channel image encoding apparatus includes a channel data processor that has a frame buffer group having a plurality of frame buffers for each input channel in order to receive a plurality of frame data through the plurality of input channels and to store the plurality of frame data. The channel data processor selects data transmitted to the frame buffer group to output the selected data. In addition, the multi-channel image encoding apparatus has an encoder for encoding image signals output from the channel data processor with an MPEG method.

It is preferable that the channel data processor stores each unit of the frame data into the frame buffer group corresponding to each channel in accordance with a set-up input channel selection order, and outputs the plurality of frame data stored in the frame buffer group to the encoder for each channel.

The channel data processor includes a first multi-switch unit for selectively contacting each of the input channels with the frame buffer group of corresponding to each of the input channels, and a second multi-switch unit for selectively contacting with the frame buffer group and outputting data output from the frame buffer group to the encoder.

The first multi-switch unit stores each unit of the frame data into the frame buffer group corresponding to the input channels in accordance with a set-up input channel selection order. The second multi-switch unit contacts with the frame buffer group in accordance with a set-up channel contact order and outputs the plurality of frame data stored in the contacted frame buffer group for each of the input channels.

The encoder includes a discrete cosine transformer for performing a discrete cosine transform with respect to the image signals input from the second multi-switch unit, a quantizer for quantizing signals output from the discrete cosine transformer and outputting the quantized signals, an inverse quantizer for inversely quantizing the quantized signals, an inverse discrete cosine transformer for performing an inverse discrete cosine transform with respect to the inversely quantized signals, a prediction memory, an adder for adding data output from the prediction memory and the inversely discrete cosine transformed data, and outputting the added data to the prediction memory, and a subtracter for subtracting data output from the prediction memory from signals input through the second multi-switch unit, and outputting the subtracted signal to the discrete cosine transformer.

The encoder further includes a variable length encoder for performing a variable length encoding with respect to signals output from the quantizer, and outputting the encoded signals, and a parser for loading channel information about each frame to signals output from the variable length encoder, and outputting the signals.

More preferably, the multi-channel image encoding apparatus further includes a channel selection unit having a key for setting up a channel select pattern in regard to the plurality of input channels, and a channel controller for controlling the first multi-switch unit and the second multi-switch unit in accordance with the channel select pattern set up by the channel selection unit.

An encoding method of a multi-channel image encoding apparatus to accomplish the above object includes the steps of selecting the input channels in accordance with a set-up order to receive a unit frame data for the input channels, storing the signals input through the selected input channels, outputting the plurality of frame data stored for each channel in accordance with a set-up selection order, and encoding a plurality of frame data output for each channel.

According to another aspect of the present invention, the multi-channel image encoding apparatus includes a channel data processor for selectively contacting with the plurality of input channels and selectively outputting transmitted image signals for each of the input channels, and an encoder for encoding signals output from the channel data processor by using a previous frame data stored in a prediction memory provided for each corresponding channel.

The channel data processor includes a first multi-switch unit for selectively contacting the input channels with frame buffer corresponding to each of the input channels, and a second multi-switch unit for selectively contacting with the frame buffer and outputting data output from the frame buffer to the encoder.

The encoder includes a discrete cosine transformer for performing a discrete cosine transform with respect to the input image signals, a quantizer for quantizing signals output from the discrete cosine transformer: an inverse quantizer for inversely quantizing the quantized signals, an inverse discrete cosine transformer for performing an inverse discrete cosine transform with respect to the inversely quantized signals, an adder for adding data output from the selected prediction memory and the inversely discrete cosine transformed data, and outputting the added data to the prediction memory of corresponding channels, a subtracter for subtracting data output from the prediction memory from signals input through the second multi-switch unit, and outputting the subtracted signal to the discrete cosine transformer, and a prediction memory selection unit for controlling the prediction memory of channels corresponding to the selected channels by the second multi-switch unit to be contacted between the adder and the subtracter.

An encoding method of multi-channel image encoding apparatus according to another aspect of the present invention to accomplish the above object includes the steps of outputting unit frame data transmitted corresponding to the set-up input channel selection order for each channel to the encoder, selecting a prediction memory of channels corresponding to the input unit frame data among the prediction memory with numbers corresponding to the number of the input channels, and encoding by using the data previously stored in the prediction memory and frame data of the currently input channel.

A multi-channel image encoding apparatus according to another aspect of the present invention includes a channel data processor for selectively contacting with the plurality of input channels and selectively outputting transmitted image information for each of the input channels, and an encoder for calculating a similarity by comparing image signals output from the channel data processor and the previous frame data stored in the frame memory provided for corresponding channels, and selecting one mode among a plurality of encoding modes set up differently for each other in regard to the present frame data in accordance with the calculated similarity and encoding according to the selected encoding mode.

It is preferable that the plurality of encoding modes includes a first mode for encoding the present frame data with an intra coding method, and a second mode for encoding data gained by subtracting the previous frame data from the present frame data.

The encoder includes an encode unit for encoding: and a similarity calculation unit for determining a corresponding encoding mode by calculating the similarity, controlling the encode unit to perform the determined encoding mode, and outputting determined encoding mode information.

The encoder includes an intra frame coder for intra coding with respect to input image signals, an intra frame decoder for decoding with respect to signals output from the intra frame coder, an adder for adding data output from the selected frame memory and data output from the intra frame decoder, and outputting the added data to the frame memory of corresponding channels, a subtracter for subtracting data output from the selected frame memory from signals input through the second multi-switch unit and outputting the subtracted signal to the intra frame coder, and a frame memory selection unit for controlling the frame memory of channels corresponding to channels selected by the second multi-switch unit in order to be contacted between the adder and the subtracter by being controlled by the similarity calculation unit.

It is preferable that the similarity calculation unit calculates a similarity by comparing previous screen data stored in the selected frame memory by the frame memory selection unit and frame data of a selected channel by the second multi-switch unit with a set-up macro block unit, and determines an encoding mode with the macro block unit.

The similarity calculation unit determines a calculated similarity as the first mode, if the calculated similarity is greater than a set-up reference value, and as the second mode, if the calculated similarity is less than a set-up reference value.

An encoding method of multi-channel image encoding apparatus according to the another aspect includes the steps of outputting unit frame data for each channel to the encoder by selecting the input channels in accordance with a set-up encode order, selecting frame memory of channels corresponding to input unit frame data among frame memory having numbers corresponding to the number of input channels, calculating a similarity by comparing data previously stored in selected frame memory with frame data of currently input channels, and encoding the present frame data by intra coding method, if the similarity is less than a set-up reference value.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram showing a multi-channel image encoding apparatus according to the first preferred embodiment of the present invention;

FIG. 2 is a block diagram showing a group of frame buffers of FIG. 1 in detail;

FIG. 3 is a flow chart showing the procedure of encoding of the multi-channel image encoding apparatus of FIG. 1;

FIG. 4 is a block diagram showing a multi-channel image encoding apparatus according to the second preferred embodiment of the present invention;

FIG. 5 is a block diagram showing the multi-channel image encoding apparatus according to the third preferred embodiment of the present invention;

FIG. 6 is a flow chart showing the procedure of encoding of the multi-channel image encoding apparatus of FIG. 5; and

FIGS. 7A through 7C are views for explaining the procedure of encoding of FIG. 6.

### DESCRIPTION OF THE PREFERRED EMBODIMENTS

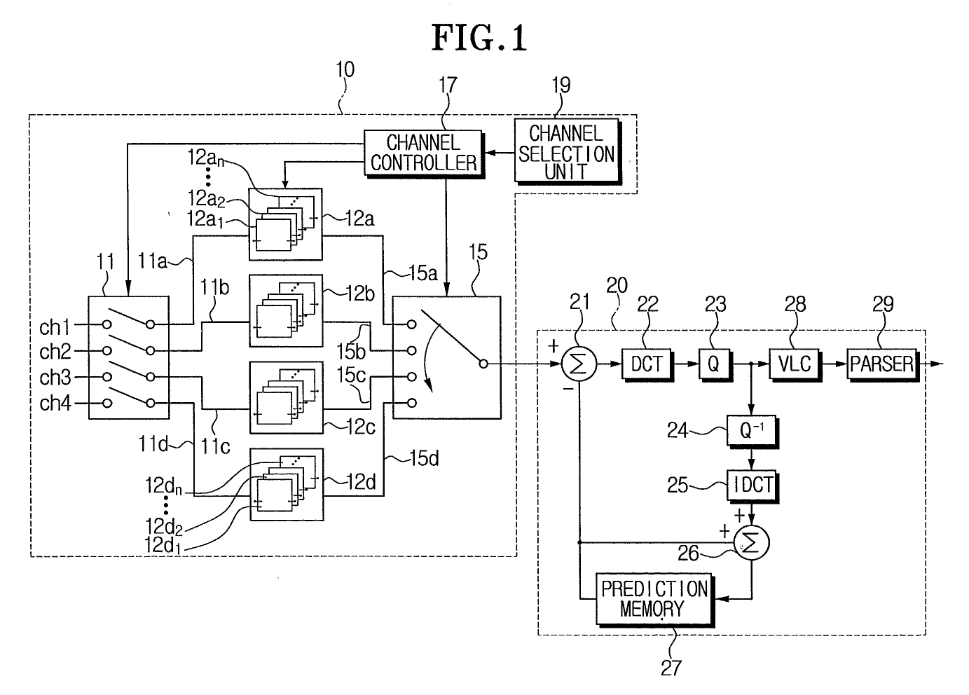

Turning now to the drawings, referring to FIG. 1, the multi-channel image encoding apparatus includes a channel data processor 10 and an encoder 20. The channel data processor 10 includes a first multi-switch unit 11, a frame data buffer group 12, and a second multi-switch unit 15. The first multi-switch unit 11 can selectively contact a plurality of input channels Ch1 to Ch4 with corresponding frame data buffer group 12a to 12d.

The frame data buffer group 12 is disposed as many as the number of the input channels. Each frame data buffer group 12 includes a plurality of frame buffers for storing a plurality of frame data. Here, the number of frame buffer of the frame data buffer group 12 can be selected within the range that can obtain a proper compression rate considering the attribute of an input images, to which the multi-channel image encoding apparatus is applied. In FIG. 1, the reference numerals 12a, through 12aₙ and 12dₗ through 12dₙ indicate that the frame data buffer group 12 has number of n frame buffers.

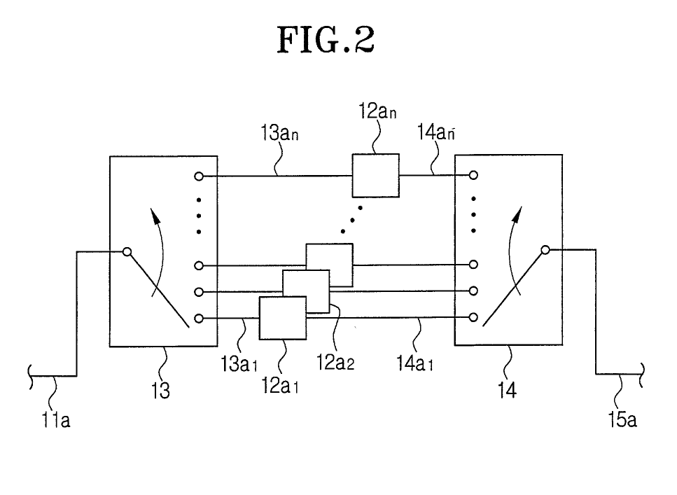

Each frame buffer of the frame data buffer group 12 can be connected with a plurality of output ends 11a through 11d corresponding to the first multi-switch unit 11 and the plurality of input ends 15a through 15d of the second multi-switch unit 15 in accordance with a set-up circulation cycle. Referring to FIG. 2, which shows one example of a frame data group, the frame data buffer group 12a includes a first multiplexer 13 for selectively connecting the input channels 13a, through 13aₙ of the frame buffers 12aₗ through 12aₙ with a corresponding output end 11a of the first multi-switch unit 11, and a second multiplexer 14 for selectively connecting the output ends 14aₗ through 14aₙ of the frame buffer 12aₗ through 12aₙ with the input end 15a of the second multi-switch unit 15. It is preferable that the switch cycle of the first multiplexer 13 and the second multiplexer 14 should be controlled by a channel control unit 17.

The second multi-switch unit 15 selects each frame buffer group 12 disposed corresponding to the input channels and outputs the frame buffer group 12 to the encoder 20.

The channel data processor 10 operates the first multi-switch unit 11 so that the frame data can be transmitted in turn for each input channel, and outputs the plurality of frame data stored in the frame data group 12 for each channel in accordance with the selection of the first multi-switch unit 11. Then, a plurality of frame data of the same channel can be output to the encoder 20 for a predetermined time, which is the switch cycle of the second multi-switch unit 15, and thus a stream structure having the similarity with an adjacent image can be offered. It is preferable that the switch cycle for each channel of the second multi-switch unit 15 is set up corresponding to a set-up GOP (group of picture).

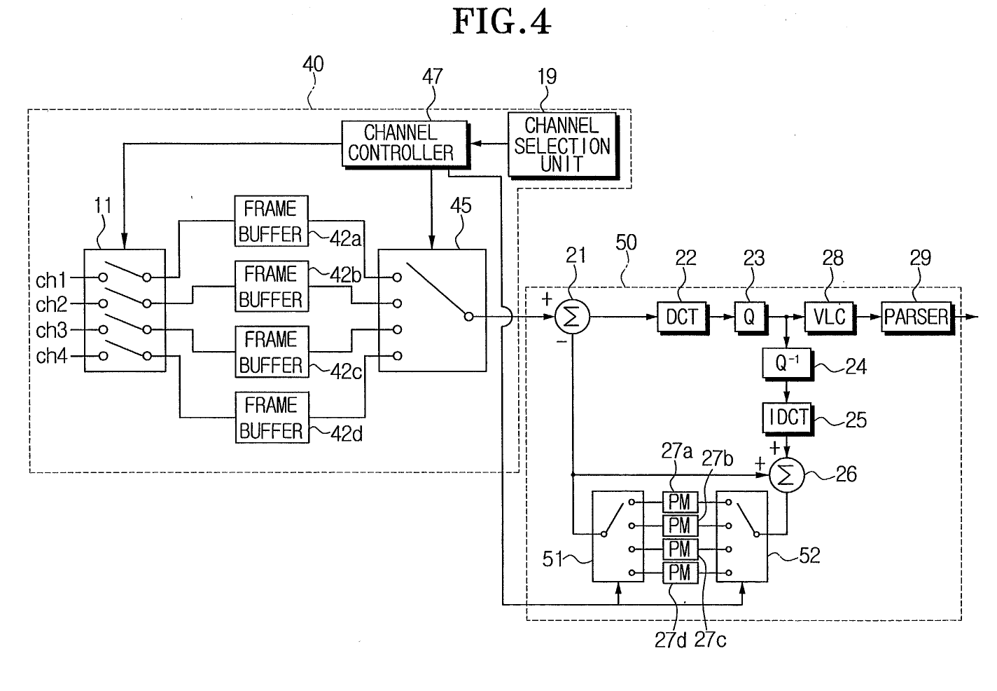

A channel selection unit 19 has a key for setting up a channel select pattern in regard to the plurality of input channels. For example, the channel selection unit 19 includes a multi-channel uniform input pattern that consecutively selects a plurality of input channels selected in regard to all or some of four input channels and applies a constant contacting time for each channel, when applying the four input channels as shown in FIG. 4. The channel selection unit 19 further includes a multi-channel variable input pattern that consecutively selects a plurality of input channels selected in regard to all or some of four input channels and applies the different contacting time or selection rate for each channel, when applying the four input channels as shown in FIG. 4. The channel selection unit 19 further includes a key for setting up one channel input pattern to select one channel.

The channel controller 17 controls the first multi-switch unit 11, the second multi-switch unit 15 and the frame buffer group 12 in accordance with a selected mode by the channel selection unit 19.

On the other hand, the channel controller 17 and the channel selection unit 19 can be omitted, when the multi-channel image encoding apparatus evenly selects the image signals for each channel in turn and codes the signals. In this case, the first multi-switch unit 11 is switched with a constant frequency so that the frame data can be transmitted for each channel in turn, and the input end of each frame buffer of the frame data group 12 is switched so that each frame buffer can consecutively store data input for each channel through the first multi-switch unit 11. Moreover, the second multi-switch unit 15 is switched to consecutively output a plurality of frame data in regard to the same channels. At this time, the switch frequency of the second multi-switch unit 15 becomes relatively longer than the switch frequency of the first switch unit 11.

The channel data processor 10 can store signals by being consecutively transmitted for each frame unit in regard to each input channel and consecutively output the plurality of frame data of the same channel consecutively stored in regard to the stored data to the encoder 20.

The encoder 20 can apply a well-known method based on MPEG-1, MPEG-2, and MPEG-4 standard.

Referring to FIG. 1 showing one example of the encoder 20, the encoder 20 includes a subtracter 21, a discrete cosine transformer (DCT) 22, a quantizer 23, an inverse quantizer 24, an inverse discrete cosine transformer (IDCT) 25, an adder 26, and a prediction memory 27.

The above elements of the encoder 20 are reviewed hereinbelow.

The subtracter 21 outputs the signal obtained by subtracting the signals about the previous frame stored in the prediction memory 27 from the signals currently input through the second multi-switch unit 15.

The discrete cosine transformer (DCT) 22 performs a discrete cosine transform with respect to signals input through the subtracter 22, and the quantizer 23 quantizes signals output from the discrete cosine transformer (DCT) 22. A variable length encoder 28 removes a statistical overlapping from the quantized signal, encodes a variable length and outputs the variable length. A parser 29 outputs signals output from the variable length encoder 28 with channel information. On the other hand, the inverse quantizer 24 inversely quantizes the quantized signals, and the inverse discrete cosine transformer (IDCT) 25 decodes the inversely quantized signals by performing an inverse discrete cosine transform.

The inverse discrete cosine transformed signal and data previously stored in the prediction memory 27 is renewed at the prediction memory 27 after being summed by the summer 26.

The encoder 20 can obtain a compression rate near to the one channel method, since the encoder 20 codes the frame data plurally input consecutively from the second multi-switch unit 15 in regard to the same channel by the MPEG method.

According to the multi-channel image encoding apparatus, there is an advantage of using an encoding chip.

The encoder 20 can be set up to encode for each channel by GOP (group of picture) unit for grouping I, P, B picture, which are within the interval of I picture capable of random accessing in regard to picture type regulated by the MPEG-2 (defining the unit for encoding in accordance with the method for movement compensation), in other words, three types of pictures, which are I (intra coded), P (predicted coded), and B (bi-directionally predicted coded).

Here, the I picture is encoded by discrete cosine transform only the picture as it is without compensating for the movement because all macro block on a screen is composed as an intra mode. The P picture in regard to the present frame applies a forward movement compensation prediction method based on the I picture of the previous frame or the P picture of the previous frame. The B picture obtains three prediction signals by using a forward prediction screen that has compensated for the movement from I/P picture of the previous frame and the I/P picture of the next frame in regard to the present frame, a backward prediction screen, and a screen (a bi-directional prediction screen) that has interpolated back and forth. After that the B picture selects the most suitable signals among these prediction signals and uses as a prediction signal.

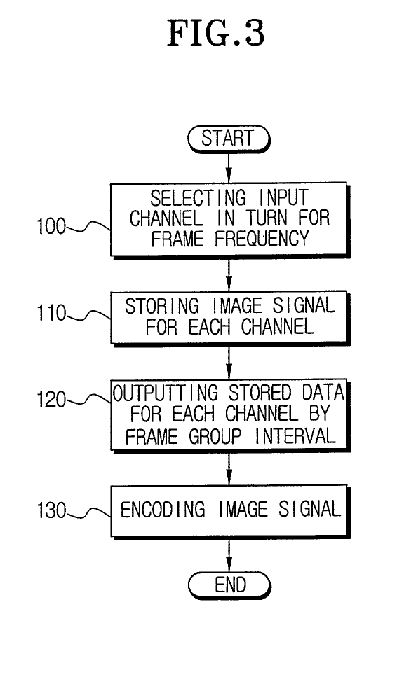

The encoding procedure of the multi-channel image encoding apparatus is shown in FIG. 3. First of all, the input channel is selected in turn by the frame interval (step 100). Then, the image signals for each channel is stored being separated from each other (step 110).

The data stored for each channel is output with the frame group interval set up for outputting a plurality of frames for each channel in regard to the data stored the frame data group 20 for each channel through the step 100 and 110 (step 120).

Then, the encoder 20 codes the plurality of frames consecutively input as many as the number of the set-up frame group in regard to the same channel into group of picture (step 130).

Referring to FIG. 4, the multi-channel image encoding apparatus according to the second preferred embodiment includes the channel data processor 40 and the encoder 50.

The channel data processor 40 selectively contacts to the plurality of input channels, and selectively outputs received image information for each channel.

The channel data processor 40 includes the first multi-switch unit 11, the frame data buffers 42a to 42d, and the multi-switch unit 45.

The first multi-switch unit 11 contacts the frame buffers 42a to 42d disposed corresponding to the number of the input channel with the frame data of the corresponding channel in accordance with the set-up channel select pattern.

The frame buffers 42a to 42d are disposed as many as the number of the input channels. The capacity of each frame buffer 42a to 42d is properly decided considering a signal process speed of a system, which is applied.

It is preferable that the switch cycle of the first multi-switch unit 11 and the switch cycle of the second multi-switch unit 45, which inputs the image signals for each channel into each frame buffer 42a to 42d and outputs the image signals stored in the frame data buffer 42a to 42d, are set up corresponding to each other.

The second multi-switch unit 45 selects each frame buffer 42a to 42d corresponding to the channel selection of the first multi-switch unit 11 and outputs the frame buffers 42a to 42d to the encoder 50.

It is preferable that the first multi-switch unit 11 and the second multi-switch unit 45 are controlled by the channel controller 47 so that the input signal selection can be unevenly applied in accordance with a need.

The channel controller 47 controls the first multi-switch unit 11, the second multi-switch unit 45 and a frame memory selection unit, which will be described later on, in accordance with a mode selected by the channel selection unit 19.

On the other hand, the channel controller 47 and the channel selection unit 19 can be omitted when the operating sequence of the elements is set up to be operated in accordance with the set-up cycle so that the image signals for each channel can be consecutively output to the encoder 50 in accordance with the channel circulation cycle. In this case, the multi-switch unit 11 is switched for a predetermined cycle so that the fame data for each channel can be consecutively transmitted in turn, and the second multi-switch unit 45 is switched so that the frame data can be consecutively output for each channel for the same cycle with the first multi-switch unit 11. At this time, a contact time of the second multi-switch unit 45 in regard to the same frame buffer is delayed for a predetermined time than the contact time of the first multi-switch unit 11.

The encoder 50 codes the frame data output in turn for each channel from the channel data processor 40 by using the data stored in the prediction memory 27a to 27d provided for each channel.

The encoder 50 includes the prediction memory selection unit 51 and 52 for selectively contacting the prediction memory 27 to contact the prediction memory unit 27 corresponding to the channel of the signals input through the second multi-switch unit 45 between the adder 26 and subtracter 21.

According to the multi-channel image encoding apparatus, the compression rate can be increased based on the compression process using the similarity of the images between the channels, as the image signals input in turn for each channel is encoded as described before by using the prediction memory 27a to 27d provided for each corresponding channel.

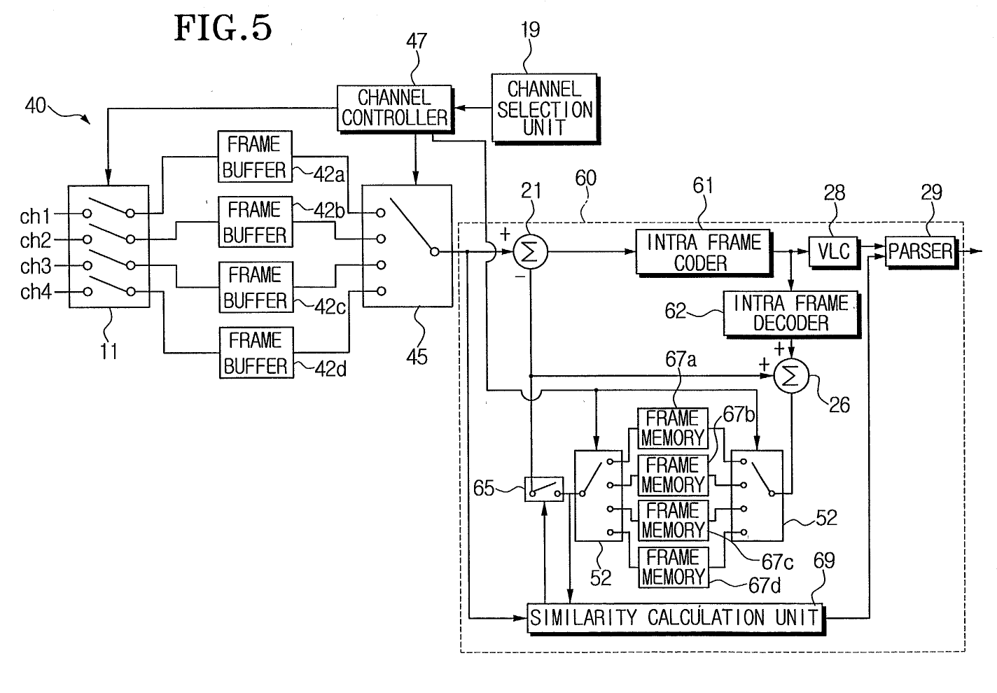

FIG. 5 is a block diagram showing the multi-channel image encoding apparatus according to the third preferred embodiment of the present invention.

Referring to FIG. 5, the multi-channel image encoding apparatus includes the channel data processor 40 and the encoder 60.

As described in FIG. 4, the channel data processor 40 outputs the data input in turn for each channel to the encoder 60 corresponding to the order of the input data. The encoder 60 includes a code unit and a similarity calculation unit 69. The code unit includes an intra frame coder 61, an intra frame decoder 62, a frame memory 67, an adder 26, a subtracter 21, and a frame memory selection unit 52.

The intra frame coder 61 encodes the input image signals according to an intra mode method. Here, the intra frame coder 61 can adopt the WAVELET and the JPEG (Joint Photographic Experts Group) coder. The intra frame decoder 61 decodes the input data to the data coded with an intra mode and outputs the decoded data. The frame memory 67 is disposed as many as the number of the input channel. The frame memory selection unit 52 selects the frame memory 67 corresponding to a channel contacted with the second multi-switch unit 45.

The similarity calculation unit 69 compares the previous screen data stored in the frame memory 67 corresponding to the signals input from the second multi-switch unit 45 with a macro block unit set up as predetermined numbers of pixels, compares the result of the comparison with a set-up reference value, and processes the data to be encoded with one of a first mode or a second mode according to the comparison result.

Here, the first mode encodes the present frame data with the intra-coding method, and the second mode encodes the data gained by subtracting the previous data from the present data. The similarity calculation unit 69 output a flag signal corresponding to the decided encoding mode to the parser 29, and controls the switch unit 65 that selects the contact of the frame memory 67 with the subtracter 21.

In other words, the similarity calculation unit 69 outputs data that has been subtracted such as the previous data of the frame memory 67 from the present data to the intra frame coder 61 through the subtracter, when the similarity of the macro block, which is compared, is greater than a set-up reference value. Moreover, the similarity calculation unit 69 encodes original signals of the corresponding macro block by opening the switch unit 65 without having a subtracting process by the intra frame coder 61, when the similarity of the macro block, which is compared, is less than the set-up reference value.

The similarity calculation unit 69 outputs flag 1, when the similarity, which is the information that tells us the type of the encoding mode when decoding, is greater than the reference value, and outputs flag 0, when the similarity is less than the reference value.

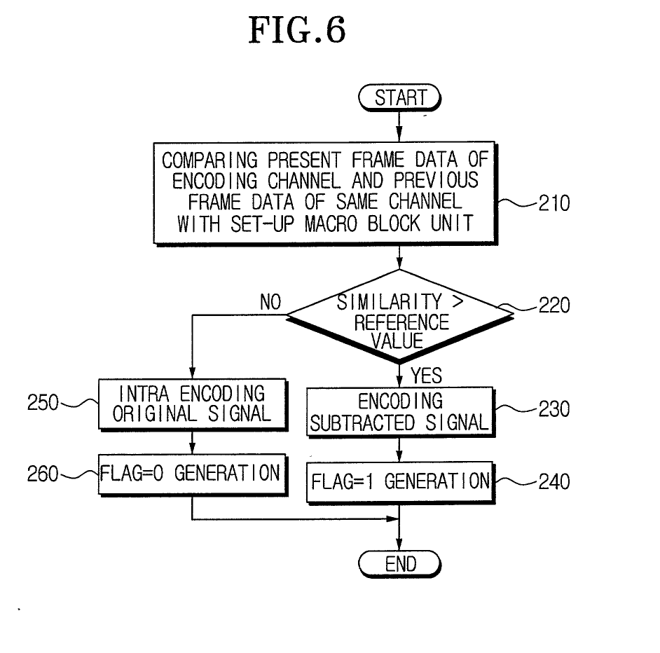

FIG. 6 shows the encoding procedure of the multi-channel image encoding apparatus.

First of all, the present frame data of the channel that is being encoded and the previous frame data of the same channel are compared with the set-up macro block (step 210).

In step 220, if the similarity is greater than the reference value, a signal, which is gained by subtracting the data of the previous frame as a corresponding macro block unit from the present frame data, is encoded (step 230). Then, the flag 1 is generated as encoding determine mode information, and output (step 240).

In the step 220, the original signal is intra-encoded (step 250), if the similarity is less than the reference value. Then, the flag 0 is generated (step 260).

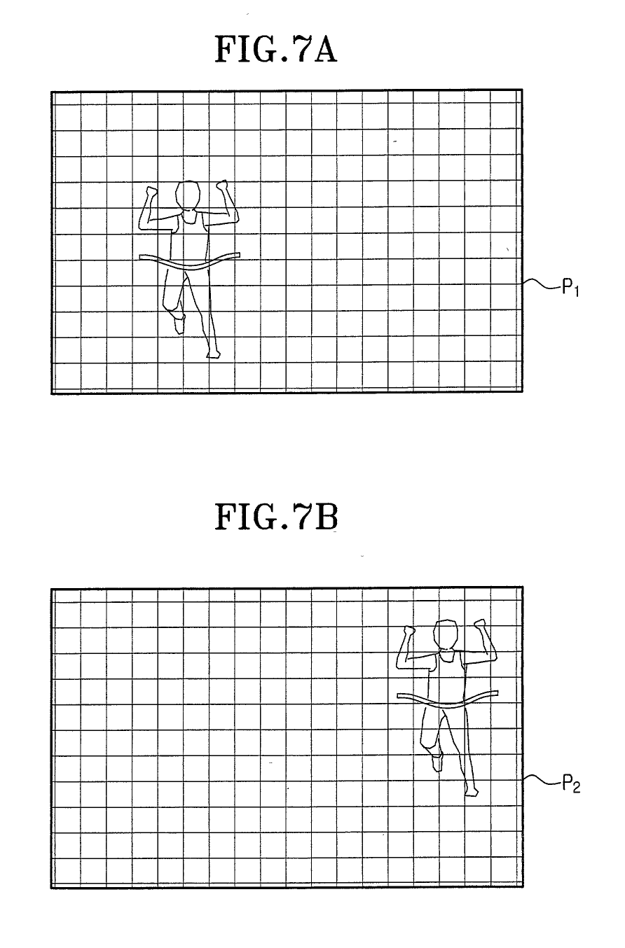

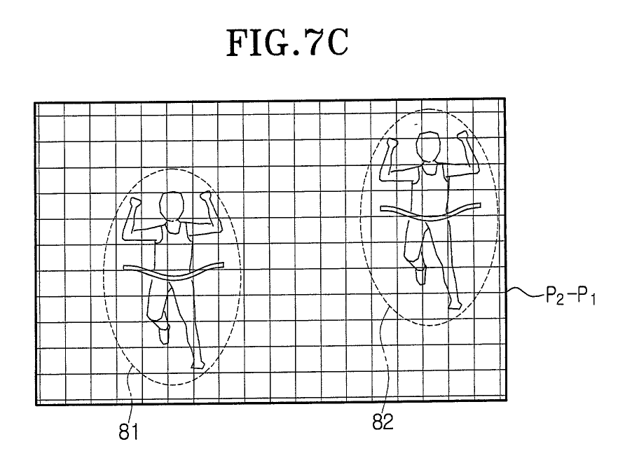

FIG. 7C shows a screen (P2−P1) corresponding to a different value, when a screen (P1) corresponding to the previous frame is FIG. 7A, and a screen (P2) corresponding to the present frame data is FIG. 7B, according to the above encoding method. The unit region divided as a chessboard type is to show an example of the macro block.

In this case, the region of FIG. 7B corresponding to two edges 81 and 82 of a runner of FIG. 7C is encoded by the intra coding without a subtracting process, and the rest of the macro block is encoded in regard to a signal by subtracting, which is most of the region data excluding the edge region of FIG. 7C. Therefore, a high compression rate will be gained, if the most part of the macro block having no changes between the previous screen and the present screen is encoded by subtracting.

As described so far, according to the multi-channel image encoding apparatus and the method thereof of the present invention, the signals for each channel input through the plurality of input channels regardless of the similarity between the channels are selected in turn and transmitted, and the compression rate can be increased, since the data of the same channels having the high similarity is compared and encoded.

Although the preferred embodiments of the present invention have been described, it will be understood by those skilled in the art that the present invention should not be limited to the described preferred embodiments, but various changes and modifications can be made within the spirit and the scope of the present invention. Accordingly, the scope of the present invention is not limited within the described range but the following claims.

What is claimed is:

1. A multi-channel image encoding apparatus for selectively receiving image signals transmitted through a plurality of input channels and encoding the image signals, comprising:
a channel data processor comprising a frame buffer group including a plurality of frame buffers for each input channel in order to receive a plurality of frame data through the plurality of input channels and to store the plurality of frame data, the channel data processor for selecting data transmitted to the frame buffer group to output the selected data; and
an encoder for encoding image signals output from the channel data processor with a Moving Picture Experts Group method.

2. The multi-channel image encoding apparatus of claim 1, further comprised of the channel data processor storing each unit of the frame data into the frame buffer group corresponding to each channel in accordance with a set-up input channel selection order, and outputting the plurality of frame data stored in the frame buffer group to the encoder for each channel.

3. The multi-channel image encoding apparatus of claim 1, with the channel data processor comprising:
a first multi-switch unit for selectively contacting each of the input channels with the frame buffer group of corresponding to each of the input channels; and
a second multi-switch unit for selectively contacting with the frame buffer group and outputting data output from the frame buffer group to the encoder.

4. The multi-channel image encoding apparatus of claim 3, further comprised of the first multi-switch unit storing each unit of the frame data into the frame buffer group corresponding to the input channels in accordance with a set-up input channel selection order, and the second multi-switch unit contacting with the frame buffer group in accordance with a set-up channel contact order and outputting the plurality of frame data stored in the contacted frame buffer group for each of the input channels.

5. The multi-channel image encoding apparatus of claim 4, with the encoder comprising:
a discrete cosine transformer for performing a discrete cosine transform with respect to the image signals input from the second multi-switch unit;
a quantizer for quantizing signals output from the discrete cosine transformer and outputting the quantized signals;
an inverse quantizer for inversely quantizing the quantized signals;
an inverse discrete cosine transformer for performing an inverse discrete cosine transform with respect to the inversely quantized signals;
a prediction memory;
an adder for adding data output from the prediction memory and the inversely discrete cosine transformed data, and outputting the added data to the prediction memory; and
a subtracter for subtracting data output from the prediction memory from signals input through the second multi-switch unit, and outputting the subtracted signal to the discrete cosine transformer.

6. The multi-channel image encoding apparatus of claim 5, with the encoder further comprising:
a variable length encoder for performing a variable length encoding with respect to signals output from the quantizer, and outputting the encoded signals; and
a parser for loading channel information about each frame to signals output from the variable length encoder, and outputting the signals.

7. The multi-channel image encoding apparatus of claim 3, further comprising:
a channel selection unit including a key for setting up a channel select pattern in regard to the plurality of input channels; and
a channel controller for controlling the first multi-switch unit and the second multi-switch unit in accordance with the channel select pattern set up by the channel selection unit.

8. An encoding method of a multi-channel image encoding apparatus for selectively receiving image signals transmitted through a plurality of input channels and encoding the image signals, comprising the steps of:
selecting the input channels in accordance with a set-up order to receive a unit frame data for the input channels;
storing the signals input through the selected input channels;
outputting the plurality of frame data stored for each channel in accordance with a set-up selection order; and
encoding a plurality of frame data output for each channel.

9. A multi-channel image encoding apparatus for encoding image signals input through a plurality of input channels, comprising:
a channel data processor for selectively contacting with the plurality of input channels and selectively outputting transmitted image signals for each of the input channels; and
an encoder for encoding signals output from the channel data processor by using a previous frame data stored in a prediction memory provided for each corresponding channel.

10. The multi-channel image encoding apparatus of claim 9, with the channel data processor comprising:
a first multi-switch unit for selectively contacting the input channels with frame buffer corresponding to each of the input channels; and
a second multi-switch unit for selectively contacting with the frame buffer and outputting data output from the frame buffer to the encoder.

11. The multi-channel image encoding apparatus of claim 10, with the encoder comprising:
a discrete cosine transformer for performing a discrete cosine transform with respect to the input image signals;
a quantizer for quantizing signals output from the discrete cosine transformer:
an inverse quantizer for inversely quantizing the quantized signals;
an inverse discrete cosine transformer for performing an inverse discrete cosine transform with respect to the inversely quantized signals;
an adder for adding data output from the selected prediction memory and the inversely discrete cosine transformed data, and outputting the added data to the prediction memory of corresponding channels;
a subtracter for subtracting data output from the prediction memory from signals input through the second multi-switch unit, and outputting the subtracted signal to the discrete cosine transformer; and
a prediction memory selection unit for controlling the prediction memory of channels corresponding to the selected channels by the second multi-switch unit to be contacted between the adder and the subtracter.

12. The multi-channel image encoding apparatus of claim 11, with the encoder comprising:
a variable length encoder for performing a variable length encoding with respect to signals output from the quantizer; and
a parser for loading channel information about each frame to signals output from the variable length encoder, and outputting the signals.

13. The multi-channel image encoding apparatus of claim 11, further comprising:
a channel selection unit having a key for setting up a channel select pattern in regard to the plurality of input channels; and
a channel controller for controlling the first multi-switch unit, the second multi-switch unit, and the prediction memory in accordance with the channel select pattern set up by the channel selection unit.

14. An encoding method of multi-channel image encoding apparatus for selectively receiving image signals transmitted through a plurality of input channels and encoding the image signals, comprising the steps of:
outputting unit frame data transmitted corresponding to the set-up input channel selection order for each channel to the encoder;
selecting a prediction memory of channels corresponding to the input unit frame data among the prediction memory with numbers corresponding to the number of the input channels; and
encoding by using the data previously stored in the prediction memory and frame data of the current input channel.

15. A multi-channel image encoding apparatus for encoding image signals input through a plurality of input channels, comprising:
a channel data processor for selectively contacting with the plurality of input channels and selectively outputting transmitted image information for each of the input channels; and
an encoder for calculating a similarity by comparing image signals output from the channel data processor and the previous frame data stored in the frame memory provided for corresponding channels, and selecting one mode among a plurality of encoding modes set up differently for each other in regard to the present frame data in accordance with the calculated similarity and encoding according to the selected encoding mode.

16. The multi-channel image encoding apparatus of claim 15, with the plurality of encoding modes comprising:
a first mode for encoding the present frame data with an intra coding method; and
a second mode for encoding data gained by subtracting the previous frame data from the present frame data.

17. The multi-channel image encoding apparatus of claim 16, with the encoder comprising:
an encode unit for encoding; and
a similarity calculation unit for determining a corresponding encoding mode by calculating the similarity, controlling the encode unit to perform the determined encoding mode, and outputting determined encoding mode information.

18. The multi-channel image encoding apparatus of claim 15, with the data processor comprising:
a first multi-switch unit for selectively contacting each of the input channels with frame buffer of corresponding channels; and
a second multi-switch unit for selectively contacting with the frame buffer, and outputting data output from the frame buffer to the encoder.

19. The multi-channel image encoding apparatus of claim 18, with the encoder comprising:
an intra frame coder for intra coding with respect to input image signals;
an intra frame decoder for decoding with respect to signals output from the intra frame coder;
an adder for adding data output from the selected frame memory and data output from the intra frame decoder, and outputting the added data to the frame memory of corresponding channels;
a subtracter for subtracting data output from the selected frame memory from signals input through the second multi-switch unit and outputting the subtracted signal to the intra frame coder; and
a frame memory selection unit for controlling the frame memory of channels corresponding to channels selected by the second multi-switch unit in order to be contacted between the adder and the subtracter by being controlled by the similarity calculation unit.

20. The multi-channel image encoding apparatus of claim 17, further comprised of the similarity calculation unit calculating a similarity by comparing previous screen data stored in the selected frame memory by the frame memory selection unit and frame data of a selected channel by the second multi-switch unit with a set-up macro block unit, and determining an encoding mode with the macro block unit.

21. The multi-channel image encoding apparatus of claim 20, further comprised of the similarity calculation unit determining a calculated similarity as the first mode, when the calculated similarity is greater than a set-up reference value, and as the second mode, when the calculated similarity is less than a set-up reference value.

22. The multi-channel image encoding apparatus of claim 19, further comprising:
a channel selection unit for setting up a channel select pattern to encode in regard to the plurality of input channels; and
a channel controller for controlling the first multi-switch unit, the second multi-switch unit, and the frame memory selection unit to encode received images in accordance with a channel select pattern selected by the channel selection unit.

23. An encoding method of multi-channel image encoding apparatus for selectively receiving image signals transmitted through a plurality of input channels and encoding the image signals, comprising the steps of:
outputting unit frame data for each channel to the encoder by selecting the input channels in accordance with a set-up encode order;
selecting frame memory of channels corresponding to input unit frame data among frame memory having numbers corresponding to the number of input channels;
calculating a similarity by comparing data previously stored in selected frame memory with frame data of currently inputted channels; and
encoding the present frame data by intra coding method, when the similarity is less than a set-up reference value.

24. The encoding method of multi-channel image encoding apparatus of claim 23, further comprised of the similarity being greater than the reference value, then data gained by subtracting previous data from present data is encoded.

25. The encoding method of multi-channel image encoding apparatus of claim 23, further comprised of the similarity calculation being performed with a set-up macro block unit.
